(19) United States
(12) Patent Application Publication
(10) Pub. No.: US 2021/0232740 A1
(43) Pub. Date: Jul. 29, 2021

(54) Design Plan Generation Device

(71) Applicant: Hitachi, Ltd., Chiyoda ku, Tokyo (JP)

(72) Inventors: Norihiko NONAKA, Tokyo (JP); Ichiro KATAOKA, Tokyo (JP)

(21) Appl. No.: 16/972,200

(22) PCT Filed: Mar. 12, 2019
(86) PCT No.: PCT/JP2019/009877

§ 371 Date: Dec. 4, 2020

(30) Foreign Application Priority Data
Jun. 28, 2018 (JP) 2018-122634

(51) Int. Cl. G06F 30/27; G06F 30/17

(52) U.S. Cl. CPC G06F 30/27; G06F 2111/02; G06F 30/17

(57) ABSTRACT

An object of the present invention is to provide a design plan generation device that is capable of obtaining information such as a configuration and performance of a mechanical structure with respect to a design specification of nonsimilar input data, and reliability of a prediction result, shortening a design period, and generating a design plan having high reliability. The design plan generation device includes: an analysis process information acquisition unit configured to acquire analysis process information in which an analysis procedure for a mechanical structure to be designed is defined; an analysis condition information acquisition unit configured to acquire analysis condition information necessary for an analysis; an analysis control unit configured to generate sampling points in a design space, execute calculation based on the analysis process information under a calculation condition corresponding to each of the sampling points, and acquire the calculation conditions and calculation results; a machine learning unit configured to execute machine learning using the calculation conditions and the calculation results, and acquire a machine learning result; a requirement specification acquisition unit configured to acquire a requirement specification of the mechanical structure; a design plan generation unit configured to generate a design plan of the mechanical structure based on the requirement specification and the machine learning result; and a reliability calculation unit configured to analyze the design space of the design plan and calculate reliability of the design plan based on an analysis result. The reliability calculation unit is configured to calculate distances to the sampling points in the design space and a first average value of the distances, calculate differences between the design plan and ones of the sampling points having shortest distances from the requirement specification among the distances and a second average value of the differences, and calculate the reliability of the design plan based on the first average value and the second average value.

### TECHNICAL FIELD

The present invention relates to a design plan generation device that generates a design plan.

### BACKGROUND ART

In the related art, there is a method of retrieving and using past design cases similar to a new design case, which is employed in a design support device using past design cases. As a background of this technical field, PTL 1 is provided. PTL 1 discloses a device that inputs designation information, which contains designated design items and design values thereof as well as designated request items and request values thereof, sets additional requirement specification information (additional request items and additional request values), and in a case where among data having a designated request value and an additional request value in a design case DB, data having a designated design value accounts for a large proportion, and among data having a designated request value but having no designated design value in the design case DB, data having an additional request value accounts for a small proportion, generates and registers a design rule for which the designation information and additional request specification information are set.

PTL 2 discloses a device, including: a request unit name acquisition section that stores a unit name of a unit to be newly designed as a request unit name; a past-record design data retrieval section that sequentially reads out past-record design data and extracts past-record design data whose unit name coincides with the request unit name; a request specification input section that generates request specification data containing the request unit name, performance items and specification values of the unit to be newly designed; and a deviation amount calculation section that reads out the extracted past-record design data and the requirement specification data, calculates a difference in the specification values between the past-record design data and the request specification data for each performance item, and calculates a deviation amount for each unit identifier, so as to sort the unit identifiers in ascending order based on the deviation amount of each unit identifier, and to provide a retrieval sequence for the unit identifiers.

In a device that calculates performance of a mechanical structure, a method is employed in which performance is subjected to response surface modeling and a response surface model is used to calculate performance of the mechanical structure. As a background of this technical field, PTL 3 is provided. PTL 3 discloses a device that creates an L-row orthogonal table for set design parameters, executes virtual trials a plurality of times by adding dimensional tolerances of each part to each of the L sets of the design parameter groups, processes an average value and a dispersion amount for L sets of evaluation indexes obtained in the virtual trials, subjects the average value and dispersion amount to response surface modeling to create a response surface model, further creates a factor-effect diagram of the design parameters for each evaluation index and examines this factor-effect diagram, creates arbitrary combinations of the design parameters that are sensitive to the evaluation index, and applies the combinations to the response surface model to create a plurality of design solutions obtained by arbitrarily combining all the design parameters that can achieve a design target value, and further performs filtering of extracting a maximum likelihood design solution candidate group that achieves limit values of evaluation indexes designated from the design solution group, so as to select a maximum likelihood design solution group, and to present it to a user.

### PRIOR ART LITERATURE

### Patent Literature

PTL 1: JP-A-2010-128710

PTL 2: JP-A-2005-276126

PTL 3: JP-A-2009-93271

### SUMMARY OF INVENTION

### Technical Problem

A design plan generation device in the related art retrieves and uses a similar case in past design cases, or uses a response surface model, so as to calculate design information and configuration and performance such as efficiency of a mechanical structure. In a technique such as retrieving a similar case, past cases are retrieved, similarities of input data and the retrieved cases are compared, and data having high similarity is output. That is, the similarities of the input data and the past cases are compared. For this reason, in a case where a design specification is taken as input data, a similar design specification is retrieved from past design specifications and is output. At this time, information linked to the output design specification, such as the configuration and performance of the mechanical structure, can be output. However, since information such as the configuration and performance of the mechanical structure with respect to a design specification of nonsimilar input data does not exist in the past design cases, it is difficult to obtain such information.

Further, for a technique of inputting a design specification and using a response surface model to predict performance such as a configuration and efficiency of a mechanical structure, a prediction result thereof is merely an approximation, and is different from an actual configuration and efficiency of the mechanical structure. Therefore, it is necessary to correct the configuration and efficiency of the mechanical structure based on the prediction result. At this time, unless reliability of the prediction result is known, it is impossible to grasp a degree of necessary correction of the design. In a case where the prediction result deviates greatly from an actual one, a design correction amount is increased, and a design period is also lengthened. With a method using a response surface model, when a simple mathematical model such as a linear equation or a quadratic equation is used, the reliability of the prediction result can be obtained using a decision coefficient or the like. However, there is a problem that it is difficult to obtain reliability of a prediction result in a complex mathematical model such as a neural network method represented by artificial intelligence.

An object of the invention is to provide a design plan generation device that is capable of obtaining information such as a configuration and performance of a mechanical structure with respect to a design specification of nonsimilar input data, and reliability of a prediction result, shortening a design period, and generating a design plan having high reliability.

### Solution to Problem

In order to solve the above problems, a design plan generation device is provided, including: an analysis process information acquisition unit configured to acquire analysis process information in which an analysis procedure for a mechanical structure to be designed is defined; an analysis condition information acquisition unit configured to acquire analysis condition information necessary for an analysis; an analysis control unit configured to generate sampling points in a design space, execute calculation based on the analysis process information under a calculation condition corresponding to each of the sampling points, and acquire the calculation conditions and calculation results; a machine learning unit configured to execute machine learning using the calculation conditions and the calculation results, and acquire a machine learning result; a requirement specification acquisition unit configured to acquire a requirement specification of the mechanical structure; a design plan generation unit configured to generate a design plan of the mechanical structure based on the requirement specification and the machine learning result; and a reliability calculation unit configured to analyze the design space of the design plan and calculate reliability of the design plan based on an analysis result. The reliability calculation unit is configured to calculate distances to the sampling points in the design space and a first average value of the distances, calculate differences between the design plan and ones of the sampling points having shortest distances from the requirement specification among the distances and a second average value of the differences, and calculate the reliability of the design plan based on the first average value and the second average value.

### Advantageous Effect

According to the invention, it is possible to provide a design plan generation device that is capable of obtaining information such as a configuration and performance of a mechanical structure with respect to a design specification of nonsimilar input data, and reliability of a prediction result, shortening a design period, and generating a design plan having high reliability.

Problems, configurations, and effects other than those described above will be apparent from the following description of embodiments.

### BRIEF DESCRIPTION OF DRAWINGS

FIG. 1 is a diagram illustrating an example of an overall configuration of a design plan generation device according to the invention.

FIG. 2 is a diagram illustrating a processing procedure (Phase 1) of the design plan generation device of the invention.

FIG. 3 is a diagram illustrating a processing procedure (Phase 1) of the design plan generation device of the invention.

FIG. 4 is a diagram illustrating a processing procedure (Phase 2) of the design plan generation device of the invention.

FIG. 5 is a diagram illustrating a processing procedure (Phase 3) of the design plan generation device of the invention.

FIG. 6 is a diagram illustrating an example of an input screen of an analysis process definition unit of the invention.

FIG. 7 is a diagram illustrating an example of an input screen of an analysis condition input/display unit of the invention.

FIG. 8 is a diagram illustrating an example of an input screen of a requirement specification input unit of the invention.

FIG. 9 is a diagram illustrating an example of an input screen of a design plan and reliability display unit of the invention.

FIG. 10 is a diagram illustrating an example of an input screen of a feedback unit of the invention.

### DESCRIPTION OF EMBODIMENTS

Hereinafter, embodiments of the invention will be described with reference to the drawings.

### Embodiment 1

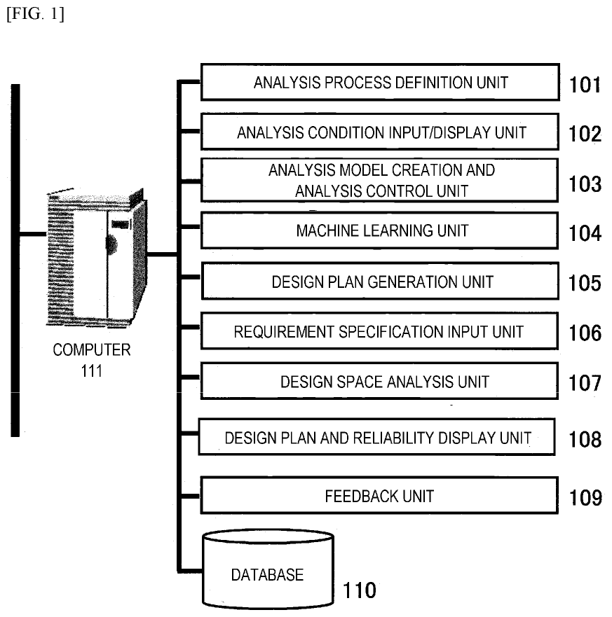

FIG. 1 is a diagram illustrating an example of an overall configuration of a design plan generation device according to the invention. As illustrated in FIG. 1, the design plan generation device according to the present embodiment includes an analysis process definition unit 101, an analysis condition input/display unit 102, an analysis model creation and analysis control unit 103, a machine learning unit 104, a design plan generation unit 105, a requirement specification input unit 106, a design space analysis unit 107, a design plan and reliability display unit 108, a feedback unit 109, a database 110, and a computer 111.

The analysis process definition unit 101, which is also an analysis process information acquisition unit, acquires analysis process information in which an analysis procedure for a mechanical structure to be designed is defined. Specifically, the analysis process definition unit 101 displays an analysis process input screen for allowing an operator to input analysis process information (analysis procedure) by dragging and dropping an analysis block in which an analysis model name and a processing program are built-in, displays the analysis process information that is input, and inputs the information, which is input, into the database 110.

The analysis condition input/display unit 102 is an analysis condition information acquisition unit that acquires analysis condition information necessary for analysis. Specifically, the analysis condition input/display unit 102 displays an analysis condition input screen for allowing an operator to input an input condition necessary for analysis with respect to an analysis model that is input with the analysis process definition unit 101, displays the analysis condition information that is input on the input screen, and inputs the information, which is input, into the database 110.

The analysis model creation and analysis control unit 103 is an analysis control unit that generates sampling points in a design space, executes calculation based on the acquired analysis process information under a calculation condition corresponding to each of the sampling points, and acquires the calculation conditions and calculation results. Specifically, the analysis model creation and analysis control unit 103 receives the analysis process information and the analysis condition information acquired by the analysis process definition unit 101 and the analysis condition input/display unit 102, generates the sampling points in the design space, creates an analysis model according to the analysis process information, executes the calculation once for each of the sampling points under the condition corresponding to each of the sampling points, and inputs calculation condition information and calculation results into the database 110 when the calculation is completed.

The machine learning unit 104 performs machine learning using the acquired calculation conditions and calculation results, and acquires a machine learning result. Specifically, the machine learning unit 104 acquires all the information from the database 110, performs machine learning about a relationship between input parameters and output parameters using a neural network that is artificial intelligence, with the calculation condition information of the sampling points being the input parameters and the calculation results being the output parameters, and inputs learning result information into the database 110.

The requirement specification input unit 106 displays a requirement specification input screen through which a requirement specification of the mechanical structure is input, and acquires the requirement specification that is input.

The design plan generation 105 generates a design plan for the mechanical structure with artificial intelligence, by using the requirement specification input through the requirement specification input unit 106 and the machine learning result learned by the machine learning 104.

The design space analysis unit 107 is a reliability calculation unit that analyzes the design space of the design plan, and calculates reliability of the design plan based on an analysis result. Specifically, the design space analysis unit 107 acquires all the information from the database 110, calculates reliability information, that is, distances to sampling points existing in the design space with respect to the input parameters (requirement specification) and an average value thereof, and differences between the sampling points close to the input parameter and the output parameter (design plan) and average values thereof, counts the number of values equal to or greater than set thresholds from obtained average values, and determines the reliability according to the number.

The design plan and reliability display unit 108 is a design plan reliability display unit that displays the calculated reliability. Specifically, the design plan and reliability display unit 108 acquires all the information from the database 110, displays a design plan and reliability display screen, and displays the requirement specification that is input, the design plan calculated by artificial intelligence, the reliability information, and the reliability.

The feedback unit 109 acquires all the information from the database 110, displays a feedback condition information input screen through which feedback input information is input, performs a parameter survey, and adds a parameter survey result calculated this time to a parameter survey result obtained so far, and performs machine learning.

The database 110 stores data obtained by the analysis model input/display unit 101, the analysis condition input/display unit 102, the analysis model creation and analysis control unit 103, the machine learning unit 104, the design plan generation unit 105, the requirement specification input unit 106, the design space analysis unit 107, the design plan and reliability display unit 108, and the feedback unit 109.

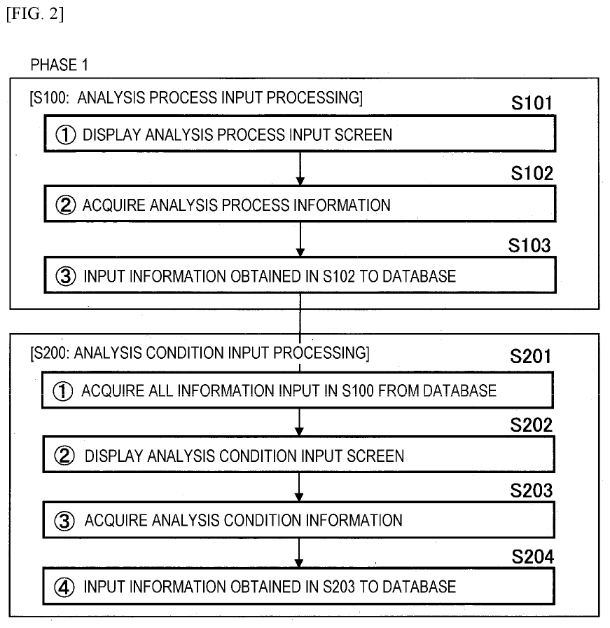

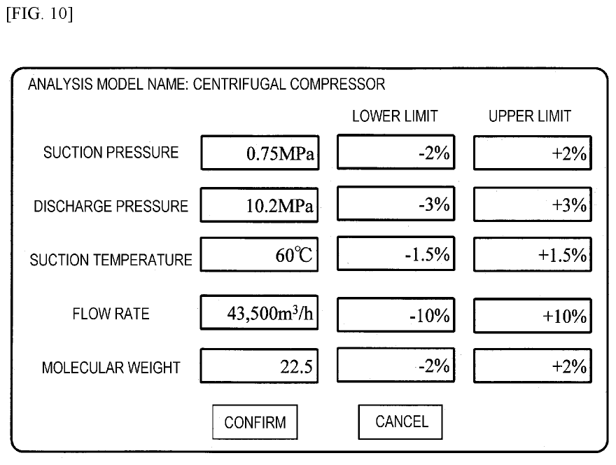

A processing procedure of the design plan generation device according to the present embodiment which is configured as described above will be described with reference to FIGS. 2 to 10. FIGS. 2, 3, 4, and 5 are flowcharts illustrating the processing procedure of the design plan generation device illustrated in FIG. 1. The procedure of the invention is roughly divided into three phases. The first phase is a phase in which an analysis process necessary for analysis and an analysis condition are input, and machine learning is performed based on an analysis result obtained by executing an analysis corresponding to the condition that is input. The second phase is a phase in which a requirement specification for a mechanical structure to be designed is input, a design plan is generated based on the input by using artificial intelligence, and reliability of the design plan which is obtained by analyzing a design space is displayed. The third phase is a phase in which an analysis point is added around the obtained design plan and analyzed, and machine learning is performed based on an obtained analysis result and feedback is performed.

A method for determining a plurality of design plans for one requirement specification for the purpose of collaborative design support will be described with reference to Phase 1, taking a centrifugal compressor of a mechanical structure as an example. A centrifugal compressor is a machine that sucks gas by rotating impellers, and compresses the gas by gradually decelerating the gas in a centrifugal direction. Normally, the centrifugal compressor is provided with a plurality of impellers instead of one impeller to compress gas. Taking the compressor as an example, a method for obtaining design plans and reliability of the obtained design plans with respect to a requirement specification for the compressor and feeding back the design plan will be described.

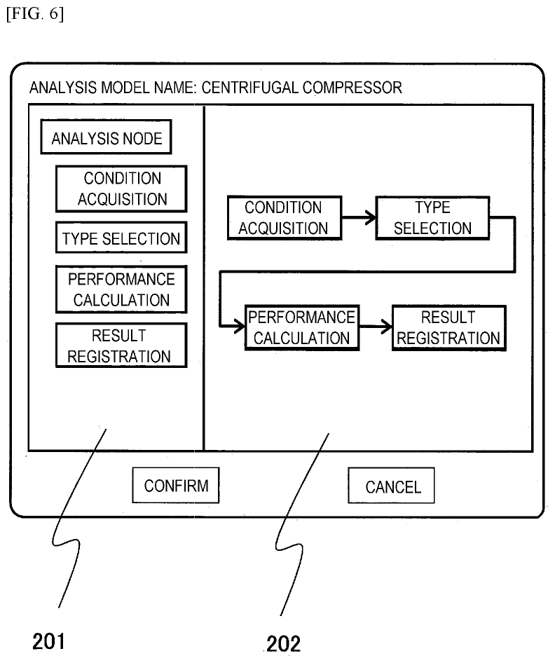

In step S100 of Phase 1 in FIG. 2, analysis process information is input from the analysis process definition unit 101. Specifically, in step S101, the analysis process definition unit 101 displays an analysis process information input screen. FIG. 6 illustrates an example of the input screen. An operator inputs the analysis process information in which an analysis procedure for analyzing a mechanical structure to be designed is defined. Here, a centrifugal compressor is input as an analysis model. A block group 201 in which a processing program called an analysis block is built-in is displayed at a left side part of the screen serving as an example. Taking a block of “condition acquisition” as an example, a processing program for acquiring a condition for analysis is built-in in the present block. Here, the block is referred to as an analysis block. Further, the analysis block is capable of executing the built-in processing program.

The operator drags the analysis block and drops the analysis block on the right side on the screen to define an analysis procedure 202 (analysis process information). Here, analysis nodes are input in the order of “condition acquisition”→“type selection”→“performance calculation”→“result registration”. In the block of “type selection”, a processing program is built-in for calculating parameters characterizing the centrifugal compressor such as the number of impeller stages, an impeller outer diameter, and an impeller rotation speed, which corresponds to the input parameters. In the block of “performance calculation”, a processing program for predicting performance of the centrifugal compressor such as a head or efficiency is built-in. In the block of “result registration”, a processing program for registering a calculation result in the database 110 is built-in.

Referring back to FIG. 2, in step S102, the analysis process information such as “condition acquisition”, “type selection”, “performance calculation”, and “result registration” input in step S101 is acquired.

In step S103, the analysis process information obtained in step S102 is acquired and input to the database 110.

In step S200 of FIG. 2, analysis condition information is input through the analysis condition input/display unit 102. Specifically, in step S201, the analysis process information input through the analysis process definition unit 101 is acquired from the database 110.

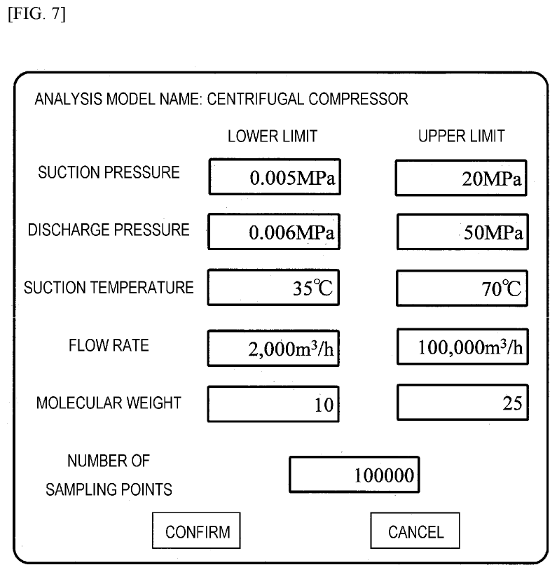

In step S202, an input screen is displayed by the analysis condition input/display unit 102. FIG. 7 illustrates an example of the input screen. The operator inputs analysis condition information necessary for analysis of the centrifugal compressor. Here, the centrifugal compressor is input as an analysis model name. Examples of the analysis condition information include a suction pressure, a discharge pressure, a suction temperature, a flow rate, and a molecular weight. Here, the operator inputs a design space condition, specifically upper limits and lower limits, in order to perform a parameter survey for performing a plurality of analyses in the design space. A lower limit 0.005 MPa and an upper limit 20 MPa for the suction pressure, a lower limit 0.006 MPa and an upper limit 50 MPa for the discharge pressure, a lower limit 35° C. and an upper limit 70° C. for the suction temperature, a lower limit 2,000 m³/h and an upper limit 100,000 m³/h for the flow rate, and a lower limit 10 and an upper limit 25 for the molecular weight are respectively input. In addition, the number of sampling points 100,000, which is the number of times the parameter survey is to be performed, is input.

Referring back to FIG. 2, in step S203, the analysis condition information input in step S202 is acquired.

In step S204, the analysis condition information obtained in step S203 is acquired and input to the database 110.

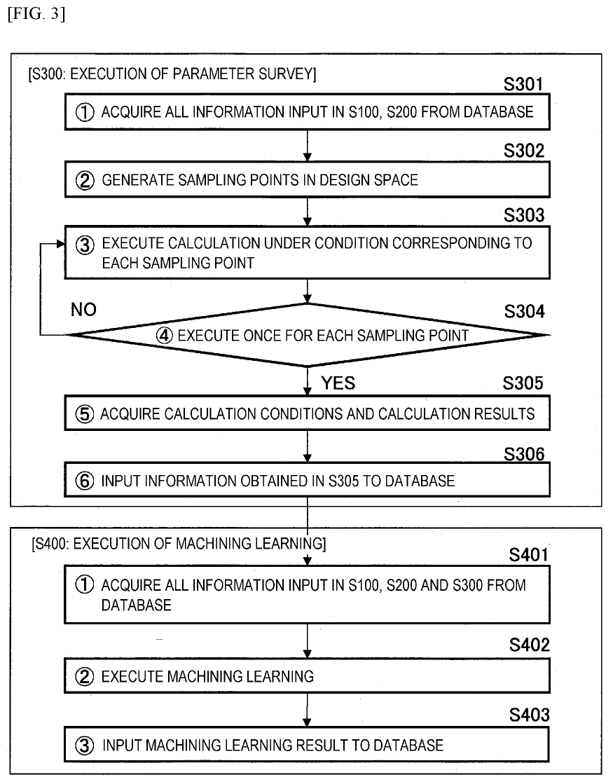

In step S300 of FIG. 3, the analysis model generation and analysis control unit 103 performs the parameter survey. Specifically, in step S301, the analysis process information input in step S100 and the analysis condition information input in step S200 are acquired from the database 110.

In step S302, sampling points that are points to be analyzed in the design space are generated. Here, the sampling points are generated in a design space of parameters such as the suction pressure and the discharge pressure input in step S202. That is, in a design space with a range of a lower limit 0.005 MPa and an upper limit 20 MPa for the suction pressure, a lower limit 0.006 MPa and an upper limit 50 MPa for the discharge pressure, a lower limit 35° C. and an upper limit 70° C. for the suction temperature, a lower limit 2,000 m³/h and an upper limit 100,000 m³/h for the flow rate, and a lower limit 10 and an upper limit 25 for the molecular weight, 100,000 sampling points are generated. There are several methods for generating sampling points, and here, the sampling points are generated using a Latin hypercube sampling (LHS) method, which is one of methods for randomly generating sampling points.

In step S303, one of the sampling points generated in step S302 is extracted, and under a calculation condition corresponding thereto, the calculation is executed in accordance with the analysis process information input in step S102. Here, the calculation is executed in the order of “condition acquisition”→“type selection”→“performance calculation”→“result registration”.

In step S304, it is determined whether the calculation has been executed for all the sampling points. If not, the process is returned to step S303 to extract one of sampling points for which the calculation has not yet been executed, and under a calculation condition corresponding thereto, the calculation is executed in accordance with the analysis process information input in step S102. If calculation has been executed for all the sampling points, the process proceeds to step S305. Here, calculation is performed for about 100,000 points.

In step S305, calculation condition information and calculation results of the sampling points generated in step S302 and step S303 are acquired.

Instep S306, the calculation condition information and the calculation results acquired in step S305 are input to the database 110.

In step S400 of FIG. 3, machine learning is performed by the machine learning unit 104 using the calculation condition information and the calculation results. Specifically, in step S401, the analysis process information input in step S100, the analysis condition information input in step S200, the calculation condition information and the calculation results input in step S300 are acquired from the database 110.

In step S402, the machine learning unit 104 performs machine learning on a relationship between the input parameters and the output parameters, using calculation condition information for the sampling points as the input parameters and the calculation results as the output parameters. The input parameters include the suction pressure, the discharge pressure, the suction temperature, the flow rate, and the molecular weight. The output parameters include the number of impeller stages, the impeller outer diameter, the impeller rotation speed, the efficiency, and the head. Here, machine learning is performed using the information of the 100,000 sampling points. There are several methods of machine learning, and a neural network, which is one type of artificial intelligence, is used here. The neural network is a mathematical model for expressing characteristics of a brain including a large number of neural cells by simulation on a computer. The neural network is given by the following recurrence Formula (1) when each layer of artificial neurons is placed as Xᵢ.

[Formula 1]

Xᵢ₊₁=f(AᵢXᵢ+Bᵢ) (1)

Here, Aᵢ and Bᵢ are a weight parameter and a bias parameter, respectively. An activation function is indicated by f. The weight parameter and bias parameter are determined through machine learning. In a case of three layers, X₁ is an input layer, X₂ is an intermediate layer, and X₃ is an output layer. A neural network in which there is a plurality of intermediate layers is referred to as a deep neural network.

In step S403, a result of the machine learning is input to the database. Here, the weight parameter Aᵢ and the bias parameter Bᵢ are learning results.

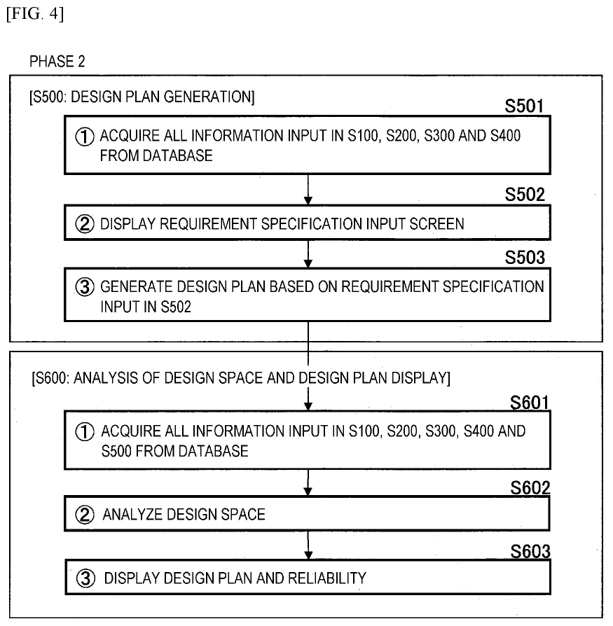

Next, Phase 2 will be described. In step S500 of FIG. 4, the design plan generation unit 105 generates a design plan based on the requirement specification that is input through the requirement specification input unit 106. Specifically, in step S501, the analysis process information input in step S100, the analysis condition information input in step S200, the calculation condition information and calculation results input in step S300, and the machine learning result of the weight parameter Aᵢ and the bias parameter Bᵢ which is input in step S400 are acquired from the database 110.

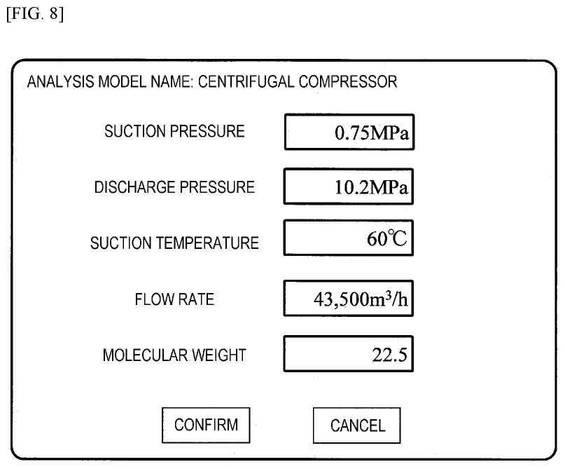

In step S502, an input screen is displayed by the requirement specification input unit 106. FIG. 8 illustrates an example of the input screen. The operator inputs a requirement specification of the centrifugal compressor to be designed from here. Here, centrifugal compressor is input as the analysis model name. Here, a suction pressure of 0.75 MPa, a discharge pressure of 10.2 MPa, a suction temperature of 60° C., a flow rate of 43,500 m^{3/}h, and a molecular weight of 22.5 are input as the requirement specifications.

Referring back to FIG. 4, in step S503, the design plan generation unit 105 generates a design plan (output parameters) using the requirement specification input in step S502 as input parameters. Here, the design plan is generated using the neural network given by the Formula (1), based on machine learning result information (weight parameter Aᵢ and bias parameter Bᵢ) obtained by machine learning by the machine learning unit 104. The neural network learns, through machine learning, a relationship between the input parameters, which include the suction pressure, the discharge pressure, the suction temperature, the flow rate, and the molecular weight, and the output parameters, which include the number of impeller stages, the impeller outer diameter, the impeller rotation speed, the efficiency, and the head, so that when new input parameters of suction pressure, discharge pressure, suction temperature, flow rate, and molecular weight are input, the number of impeller stages, an impeller outer diameter, an impeller rotation speed, efficiency, and a head can be output based on a learning result.

In step S600 of FIG. 4, the design space analysis unit 107 analyzes the design space and calculates reliability of the design plan obtained by the design plan generation unit 105, and the design plan and reliability display unit 109 displays the reliability together with the design plan that is obtained by the design plan generation unit 105. Specifically, in step S601, the analysis process information input in step S100, the analysis condition information input in step S200, the calculation condition information and the calculation results input in step S300, the machine learning result of the weight parameter Aᵢ and the bias parameter Bᵢ which is input instep S400, and the design plan input in step S500 are acquired from the database 110.

In step S602, the design space is analyzed to calculate the reliability of the design plan obtained by the design plan generation unit 105. Here, a distance from a requirement specification (input parameters) input through the requirement specification input unit 106 with respect to a sampling point present in the design space generated in step S302 is calculated. The distance is calculated by the following Formula (2).

[Formula 2]

Lⁱ=√(x₁−x₁ⁱ)*(x₁−x₁ⁱ)+Λ+(x₅−x₅ⁱ)*(x₅−x₅ⁱ) (2)

L represents a distance, x represents an input parameter, and a subscript represents an index. Here, x₁ is the suction pressure, x₂ is the discharge pressure, x₃ is the suction temperature, x₄ is the flow rate, and x₅ is the molecular weight. A superscript means a sampling point.

Next, an average L^{avg} (first average value) of distances with respect to the input parameters is calculated. Next, N sampling points having the smallest distances obtained by Formula (2) from the input parameters are extracted. Here, N=10.

Next, after calculating differences between the output parameters of the N sampling points and the output parameters generated as the design plan obtained by the design plan generation unit 105 is calculated, averages Y^{avg} (second average value) of these differences given by the following Formula (3) are calculated.

$$\begin{matrix}[ Formula 3 ] & \\ {Y}_{j}^{AVG} = \frac{\sum \vert {Y}_{j} - {Y}_{j}^{k} \vert}{N} & ( 3 )\end{matrix}$$

Y represents an output parameter, a subscript j represents an index, Y₁ represents the number of impeller stages, Y₂ represents the impeller outer diameter, Y₃ represents the impeller rotation speed, Y₄ represents the efficiency, and Y₅ represents the head. A superscript k represents the N sampling points from the smallest distances obtained by Formula (3).

Next, the reliability is calculated. The reliability is calculated based on 1) the distances to the sampling points in the design space, 2) the first average value of the distances, 3) the differences between the design plan and the sampling points having the shortest distances from the requirement specification among the distances and 4) the second average values of the differences. Specifically, thresholds are provided for the first average value L^{avg} and the second average values Y^{avg} respectively, which are the reliability information, and the number P of the parameters equal to or greater than the threshold is counted. Here, the number of parameters is 6, including the distance, the number of impeller stages, the impeller outer diameter, the impeller rotation speed, the efficiency, and the head. Here, the reliability is set to “A” when P is 0, is set to “B” when P is 2 or less, and is set to “C” when greater than that.

In step S603, the design plan and reliability display unit 108 displays the design plan obtained by the design plan generation unit 105 and the reliability obtained by the design space analysis unit 107 on a design plan and reliability display screen.

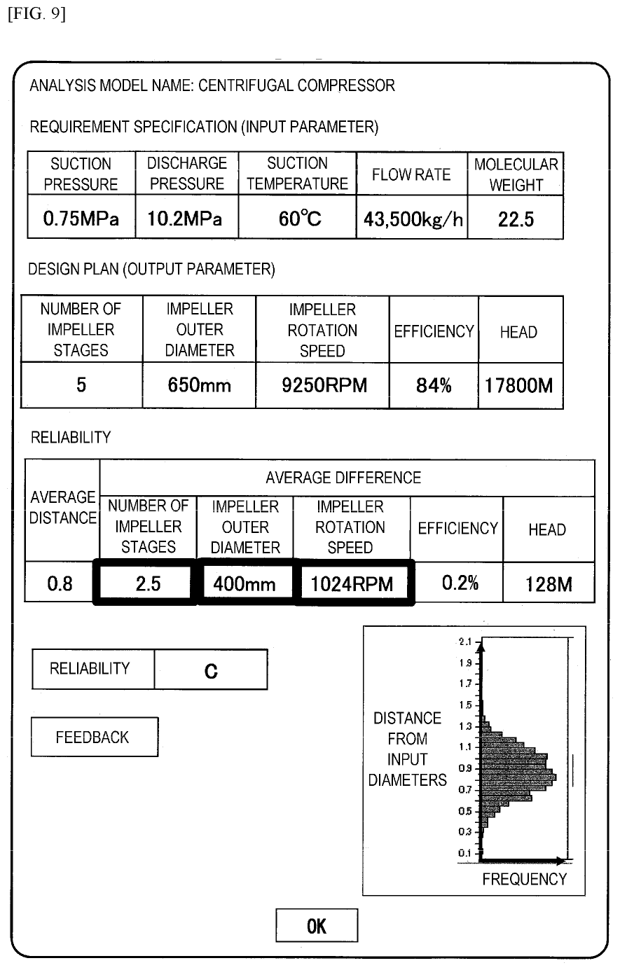

FIG. 9 illustrates an example of the design plan and reliability display screen. The requirement specification (input parameters) is displayed, and the design plan (output parameters) corresponding to the requirement specification which is calculated by artificial intelligence is displayed. As illustrated in the drawing, the information of L^{avg}, Y^{avg}, and the reliability information are displayed together with the design plan obtained by the design plan generation unit 105. Here, the reliability is displayed as the average distance, and the average differences for the number of impeller stages, the impeller outer diameter, the impeller rotation speed, the efficiency, and the head. The parameters that exceed thresholds thereof are highlighted in bold frames. In addition, a frequency distribution is also displayed where the distance L from the input parameters is taken on a vertical axis and a frequency of the sampling points with respect to the distance is taken on the horizontal axis. An average thereof is the average distance. In addition, the reliability is also displayed. Specifically, the operator feeds back the calculated reliability to generation of a next design plan, and specifically, performs feedback by pressing a “feedback” button in accordance with the reliability, to improve the reliability.

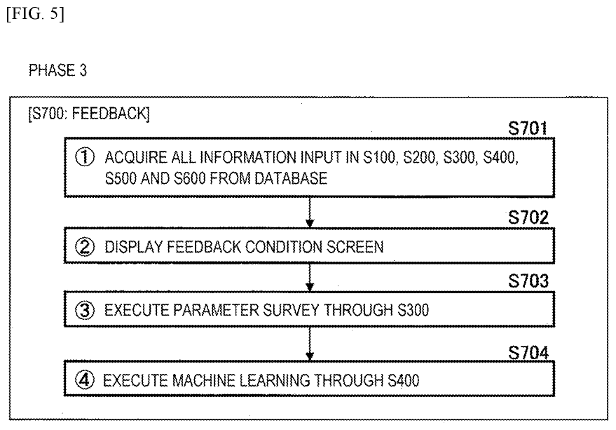

Next, Phase 3 will now be described. In step S700 of FIG. 5, the parameter survey is executed according to a generation range of the sampling point input by the feedback unit 109, and machine learning is executed. Specifically, in step S701, the analysis process information input in step S100, the analysis condition information input in step S200, the calculation condition information and the calculation results input in step S300, the machine learning result of the weight parameter Aᵢ and the bias parameter Bᵢ which is input in step S400, the design plan input in step S500, and the reliability information input in step S600 are acquired from the database 110.

In step S702, a feedback condition screen is displayed. FIG. illustrates an example of the screen. The requirement specifications input in Phase 2 is displayed. The operator inputs a lower limit and an upper limit for each input parameter that is the requirement specification. Here, a lower limit −2% and an upper limit +2% for the suction pressure, a lower limit −3% and an upper limit +3% for the discharge pressure, a lower limit −1.5% and an upper limit +1.5% for the suction temperature, a lower limit −10% and an upper limit +10% for the flow rate, and a lower limit −2% and an upper limit +2% for the molecular weight are input.

Referring back to FIG. 5, in step S703, the parameter survey is executed through step S300. Here, a sampling point is generated according to the lower limit and the upper limit of each input parameter, and the calculation is executed in accordance with the analysis process information input in step S102, and a new calculation condition and a new calculation result are acquired.

Thus, the reliability of a design plan is improved by inputting the requirement specification, creating a design plan by artificial intelligence, displaying the reliability of the design plan to the operator, and performing feedback.

In step S704, the machine learning is executed through step S400. Here, the machine learning is executed through step S400 by adding the new calculation condition and the new calculation result obtained in step S703 to the information of the sampling points obtained so far.

In the invention, a neural network is used for machine learning, and alternatively other artificial intelligence methods such as a kriging method can be used.

Although an analysis node analysis included in the analysis process is described as being performed by the same computer in the invention, the analysis node analysis can be performed in different computers by using a network environment.

The invention is not limited to the above embodiments, and includes various modifications. For example, the embodiments described above have been described in detail for easy understanding of the invention, and the invention is not necessarily limited to those including all configurations described above.

### REFERENCE SIGN LIST

101 analysis process definition unit
102 analysis condition input/display unit
103 analysis model creation and analysis control unit
104 machine learning unit
105 design plan generation unit
106 requirement specification input unit
107 design space analysis unit
108 design plan and reliability display unit
109 feedback unit
110 database
111 computer
201 block group
202 analysis procedure

1. A design plan generation device, comprising:
an analysis process information acquisition unit configured to acquire analysis process information in which an analysis procedure for a mechanical structure to be designed is defined;
an analysis condition information acquisition unit configured to acquire analysis condition information necessary for an analysis;
an analysis control unit configured to generate sampling points in a design space, execute calculation based on the analysis process information under a calculation condition corresponding to each of the sampling points, and acquire the calculation conditions and calculation results;
a machine learning unit configured to execute machine learning using the calculation conditions and the calculation results, and acquire a machine learning result;
a requirement specification acquisition unit configured to acquire a requirement specification of the mechanical structure;
a design plan generation unit configured to generate a design plan of the mechanical structure based on the requirement specification and the machine learning result; and
a reliability calculation unit configured to analyze the design space of the design plan and calculate reliability of the design plan based on an analysis result,
wherein the reliability calculation unit is configured to calculate distances to the sampling points in the design space and a first average value of the distances, calculate differences between the design plan and ones of the sampling points having shortest distances from the requirement specification among the distances and a second average value of the differences, and calculate the reliability of the design plan based on the first average value and the second average value.

2. The design plan generation device according to claim 1, further comprising:
a design plan reliability display unit configured to display the reliability.

3. The design plan generation device according to claim 2,
wherein the design plan reliability display unit is configured to display the requirement specification and the design plan together with the reliability.

4. The design plan generation device according to claim 1, further comprising:
a feedback unit configured to feedback the reliability for next design plan generation.
